(19) United States
(12) Patent Application Publication
(10) Pub. No.: US 2009/0014679 A1
(43) Pub. Date: Jan. 15, 2009

(54) Plastic aerosol valve and method of assembly, mounting and retention

(75) Inventors: Terry L. Hygema, Greer, SC (US); Geoff Brace, Columbus, NC (US); John B. Fore, Travelers Rest, SC (US); Randy J. Flynn, Oshawa (CA)

Correspondence Address: Daniel H. Steidl;KILGANNON & STEIDL, 85 Pondfield Road, Bronxville, NY, 10708, US

(73) Assignee: PRECISION VALVE CORPORATION, New York, NY (US)

(21) Appl. No.: 11/827,712

(22) Filed: Jul. 13, 2007

(51) Int. Cl. F16K 51/00; B21K 1/20

(52) U.S. Cl. 251/368; 29/890.124

(57) ABSTRACT

A plastic aerosol valve with a plastic valve stem, plastic housing, plastic mounting cup, and plastic locking ring. The plastic valve is assembled into the mounting cup. The plastic housing is assembled into the plastic mounting cup by snap fittings. The plastic mounting cup has a peripheral portion that snap fits up into the plastic locking ring. The plastic locking ring has frangibly-connected upper and lower portions. The lower portion snap fits with the top of a plastic product bottle to mount the aerosol valve assembly on the bottle. The upper ring portion thereafter is telescoped downwardly over the lower ring portion to lock and retain the aerosol valve assembly on the pressurized bottle. The plastic mounting cup can be molded separately, or integrally with the plastic locking ring. A check valve may be contained in the valve stem.

### FIELD OF THE INVENTION

The present invention relates to aerosol valves. More particularly, this invention relates to a new design of plastic aerosol valve and the method of assembling the valve, mounting the valve onto a preferably plastic container, and retaining the valve on the container.

### BACKGROUND OF THE INVENTION

The most common and long existing aerosol valve design generally comprises a plastic valve stem mounted within a plastic valve housing which in turn is mounted into a metal mounting cup. The metal mounting cup is formed with a central pedestal portion having a central opening for the plastic valve stem. The metal pedestal portion is clinched by machine tooling onto the plastic valve housing to retain the housing in the mounting cup. The metal mounting cup also has an outer portion with a circumferential channel and an outer skirt. The channel is fitted onto the bead about the top opening of a generally metal aerosol product container for holding propellant and the product to be dispensed through the aerosol valve. The metal skirt at the periphery of the mounting cup is crimped by machine tooling about the container bead to attach and retain the mounting cup on the product container. The aforesaid describes a very satisfactory aerosol valve assembly, but one which has certain cost considerations relating to the metal mounting cup and the machine tooling to mount the plastic valve housing in the mounting cup pedestal and to mount and retain the mounting cup onto the bead of the aerosol product container.

Attempts have been made at various times to design plastic mounting cups and attach and retain such to metal or plastic product containers. These attempts have generally not been successful commercially, due to concerns about reliable and non-removable retention and sealing of the mounting cup, potential assembly issues, etc.

Accordingly, it would be highly desirable to obtain a plastic aerosol valve which is easily, quickly and cheaply built and designed for quick and reliable assembly, as well as quick and reliable mounting and retention of the plastic aerosol valve in sealed fashion on the aerosol product container.

### SUMMARY OF THE INVENTION

The present invention includes a preferably plastic (PET for example) bottle, although a metal container of specific neck construction could also be used. A molded plastic mounting cup, as well as a valve stem, valve housing and dip tube all of molded plastic, are utilized for the aerosol valve. Additionally a plastic locking ring is utilized for functionally connecting and retaining the plastic mounting cup on the plastic bottle. All of the plastic components may also be PET (polyethylene terephthalate), or PEN (polyethylene naphthalate) or other plastics.

The mounting cup is not only made of plastic, with attendant cost, assembly and mounting advantages, but also has structure that differs from the usual metal mounting cup of aerosol valves. Additionally, the plastic valve housing of the present invention has a structure different from conventional aerosol plastic valve housings. Both the plastic mounting cup and valve housing of the present invention have features for snap action interconnection, and after the valve stem and stem gasket are assembled into the mounting cup, the cup and housing snap-action features allow the cup and housing to be assembled to one another without the metal clinching tooling required by metal mounting cups. The valve housing, valve stem and stem gasket are thereby retained in the mounting cup.

In a first embodiment of the present invention, the plastic mounting cup has a circumferential flange at its periphery that in turn fits within a plastic locking ring having an upper and a lower portion. In a second embodiment of the present invention, the plastic mounting cup is molded integrally with the plastic locking ring. In both embodiments the lower portion of the plastic locking ring has snap features for engaging the plastic bottle between flanges on the neck of the bottle. In both embodiments the upper portion of the plastic locking ring is molded integrally with the lower portion so as to be connected to the lower portion by one or more thin frangible connections. The inner circumference of the upper portion approximates the outer circumference of the lower portion, so that when the fully-assembled aerosol valve with locking ring is mounted onto the neck of the PET bottle, the upper portion of the locking ring may then be pushed downward to telescope over the lower portion. In that telescoped or coaxial position the formerly upper portion provides hoop strength pressing against the inner lower portion of the locking ring to retain the locking ring firmly affixed to the neck of the PET bottle. A mounting cup sealing gasket seals the mounting cup against the top of the neck of the plastic bottle.

As a further alternative, it may be desirable to substitute a metal upper portion of the locking ring in place of the plastic upper portion. Such a substitution could provide potentially desirable decorative possibilities as well as potentially desirable increased hoop strength to counteract planned higher internal pressures in the product container. With such a substitution, the lower portion of the locking ring will remain plastic and the metal upper portion will be mounted over the top of the lower plastic portion for subsequent telescoping downwardly.

It will be appreciated that the assembled aerosol valve will generally be sold to fillers with the upper portion of the locking ring in its upper, non-telescoped position. After the PET bottle is filled by the filler with the product to be dispensed, the filler will attach the aerosol valve assembly by pushing it down onto the PET bottle in the manner as referenced above, and will then push the upper portion of the locking ring down to telescope over the lower portion. The speed and ease at which these push-down operations can be carried out is a decided advantage of the present invention.

It is therefore apparent that the aerosol valve of the present invention can be assembled by simple insertion of parts, snap action features of the plastic parts, and locking and retaining features of the plastic parts. The necessity in the prior art of machine tools to clinch and crimp metal mounting cups onto valve housings and onto product containers is thereby avoided.

The present invention also can be free of metal parts, and is easily recycled. No metal spring is required in the present invention to maintain the valve closed in the absence of actuation, with the flex of the stem gasket acting against a groove in the valve stem to close the aerosol valve after actuation. If desired, however, metal (or plastic) return springs may be utilized.

The present invention further may include a check valve movable in the valve stem to hinder loss of propellent gas if the plastic valve and bottle are actuated in the inverted position.

Other features and advantages of the present invention will be apparent from the following description, drawings and claims.

### BRIEF DESCRIPTION OF THE DRAWINGS

FIG. 1 is a side elevation of a plastic PET bottle having the plastic aerosol valve of the present invention mounted thereto;

FIG. 2 is a perspective view of the separate components of a first embodiment of the present invention before assembly;

FIG. 3 is a perspective view towards the top of the plastic mounting cup component of FIG. 2 with the plastic valve stem and stem gasket components mounted therein;

FIG. 4 is a side elevation diametrical cross-sectional view taken along lines 4-4 of FIG. 3;

FIG. 5 is a perspective view towards the bottom of the plastic mounting cup component of FIG. 2 with the assembled plastic valve housing, valve stem and stem gasket components mounted therein;

FIG. 6 is a side elevation diametrical cross-sectional view taken along lines 6-6 of FIG. 5;

FIG. 7 is a perspective view towards the top of the plastic locking ring component of FIG. 2, with the top portion of the locking ring component in a first position and with the assembled plastic mounting cup, plastic valve housing, plastic valve stem and stem gasket components mounted in the locking ring;

FIG. 8 is a side elevation diametrical cross-sectional view taken along lines 8-8 of FIG. 7;

FIG. 9 is a side elevation diametrical cross-sectional view corresponding to FIG. 8 with the mounting cup sealing gasket and dip tube components of FIG. 2 added to the assembly;

FIG. 10 is a perspective view towards the top of the aerosol valve assembly of FIG. 9 as mounted onto the plastic PET bottle of FIG. 1;

FIG. 11 is a side elevation diametrical cross-sectional view taken along lines 11-11 of FIG. 10;

FIG. 12 is a perspective view towards the top of the aerosol valve assembly of FIGS. 10 and 11, but with the top portion of the plastic locking ring component in a second, lowered, retaining position;

FIG. 13 is a side elevation diametrical cross-sectional view taken along lines 13-13 of FIG. 12;

FIG. 14 is a view of separate components of a second embodiment of the plastic aerosol valve of the present invention before assembly;

FIG. 15 is a side elevation diametrical cross-sectional view of the assembled components of FIG. 14 before mounting onto the plastic PET bottle of FIG. 1;

FIG. 16 is a side elevation diametrical cross-sectional view corresponding to FIG. 15 but with the assembled components of the plastic aerosol valve mounted and retained on the plastic PET bottle of FIG. 1; and

FIG. 17 is an enlarged view of the top portion of FIG. 16.

### DETAILED DESCRIPTION OF EMBODIMENTS

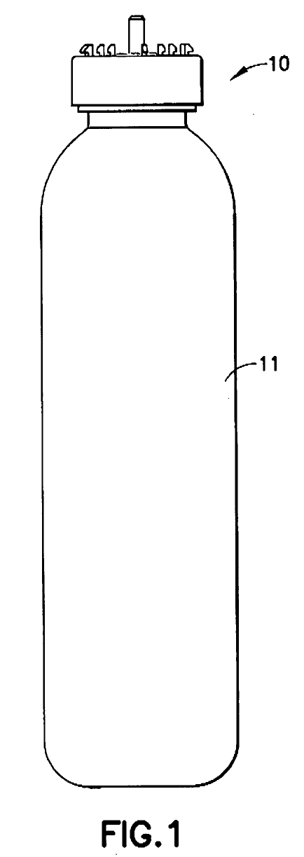

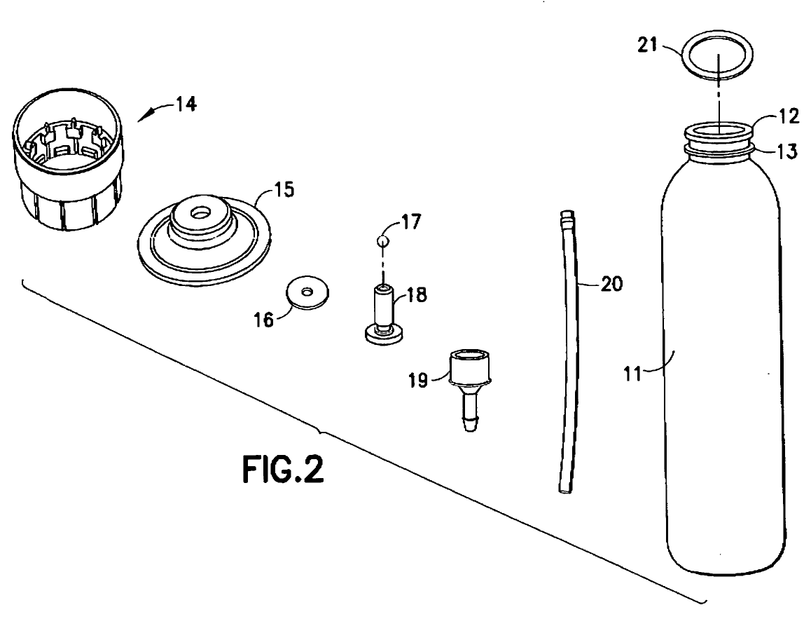

Referring to FIG. 1, the assembled plastic aerosol valve 10 of the present invention is shown mounted to the top of plastic PET bottle 11. FIG. 2 illustrates bottle 11 having spaced circumferential flanges 12 and 13 extending outwardly on the neck of the bottle. The components of plastic aerosol valve 10 are shown in FIG. 2, comprising plastic locking ring 14, plastic mounting cup 15, rubber (or TPE) stem gasket 16, ball check valve 17, plastic valve stem 18, plastic valve housing 19, plastic dip tube 20, and rubber (or TPE) mounting cup sealing gasket 21. The plastic of the locking ring 14, mounting cup 15, valve stem 18, valve housing 19 and dip tube 20 may also be PET. The mounting cup 15, valve stem 18, stem gasket 16, valve housing 19 and dip tube 20 of the present invention broadly perform the usual well-known functions of such elements in an aerosol valve. The valve stem, stem gasket and valve housing are captured within the mounting cup and the dip tube is attached to the valve housing to extend into product in the aerosol container. When the aerosol valve stem is not actuated, the valve stem seals with the stem gasket to prevent product exiting the product container. When the valve stem is actuated, the valve stem and stem gasket no longer block product flow and product exits the valve stem.

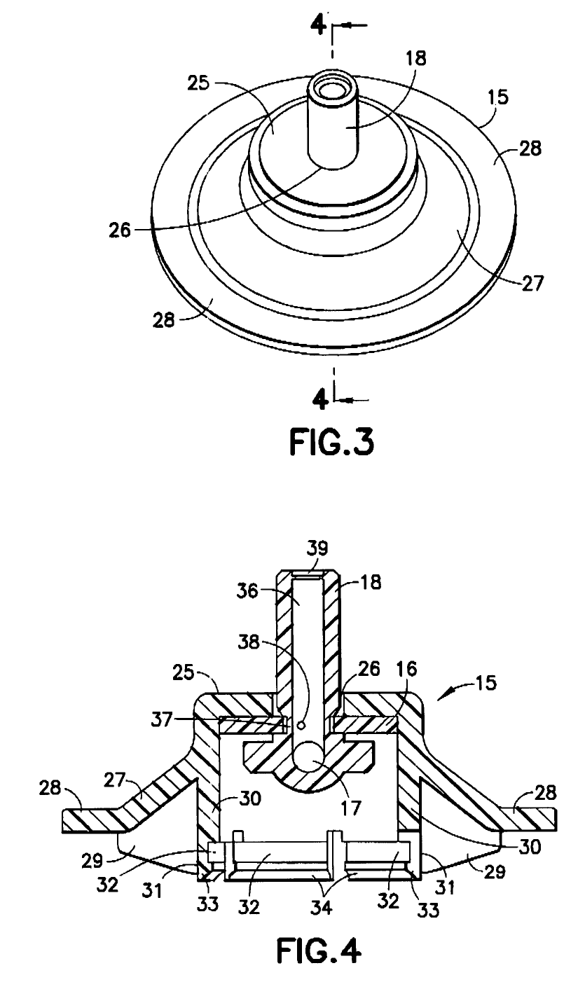

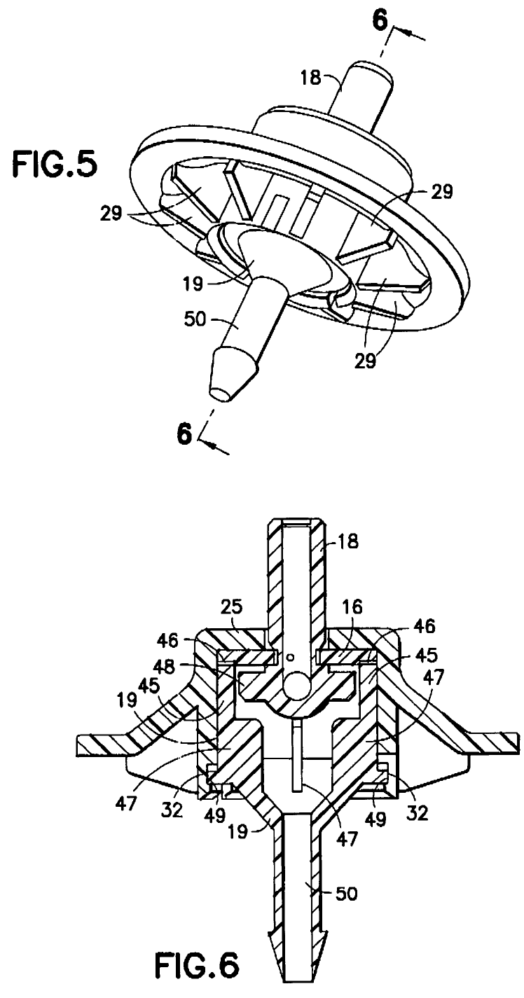

Referring to FIGS. 3 and 4, mounting cup 15 has an upper pedestal portion 25 having an opening 26 therein through which valve stem 18 may extend. Mounting cup 15 also has downwardly and outwardly angled portion 27 terminating in circumferential horizontal portion 28 at the cup periphery. A series of ribs 29 (also see FIG. 5) extend around the mounting cup between cup angled portion 27 and cup vertical cylindrical wall 30, in order to provide structural stability to the plastic mounting cup. Depending downwardly from and extending around the base of wall 30 of the plastic mounting cup are a series of legs 31, each having a slot 32 therein and inwardly extending flanges 33 with lead-in ramps 34. The slots 32 and flanges 33 provide snap fittings for the plastic valve housing as hereafter described.

In the subassembly of FIGS. 3 and 4, stem gasket 16 with a central hole has been inserted over valve stem 18 and the stem with gasket has been inserted into mounting cup 15. Valve stem 18 has vertical internal product passageway 36, circumferential groove 37 and lateral product passageway 38 connecting groove 37 and vertical passageway 36. Stem gasket 16 extends into groove 37 to seal lateral passage 38 when the valve is not actuated. When valve stem 18 is depressed upon actuation, it flexes the inner portion of the stem gasket 16 downwardly to allow product flow through passageway 38. The inner portion of the stem gasket 16 still remains partially within stem groove 37, and when actuation ceases, the downwardly flexed stem gasket 16 flexes back upwardly against the groove surface to return valve stem 18 to its upper closed position. The pressure of the aerosol propellant in the product bottle may also assist this action.

Valve stem 18 further has an internal rib 39 in passage 36 as shown in FIG. 4. Check ball 17 may be pushed past that rib upon subassembly, and will fall to the bottom of passageway 36 below lateral opening 38. If the filled bottle 11 is inverted and actuation is attempted, the ball 17 will roll and extend against rib 39 to block the escape of propellant gas. Rib 39 will have a small notch therein to break the seal of ball 17 and rib 39 when bottle 11 is turned back upright.

Now turning to FIGS. 5 and 6, plastic housing 19 is shown assembled by snap-fitting into the mounting cup-valve stem subassembly of FIGS. 3 and 4. Housing 19 has an upper cylindrical portion 45 which at its top 46 seals with valve stem gasket 16 and presses gasket 16 upwards against pedestal 25. Extending downwardly from housing upper portion 45 is an intermediate portion having inwardly extending ribs 47 spaced circumferentially about the valve housing. These ribs 47 define the downward limit of travel of the base 48 of valve stem 18 in the assembly of FIGS. 3 and 4 and thus lock valve stem 18 in place. At the bottom of the intermediate portion of housing 19 is an outwardly extending circumferential flange 49. When valve housing 19 is assembled into the plastic mounting cup 16 through its bottom, the circumferential flange 49 is cammed up ramps 34 (see FIG. 4) and snaps into slot 32 of the mounting cup (see FIG. 4) to complete the subassembly of mounting cup 15, valve stem gasket 16 and valve stem 18, and valve housing 19.

Plastic housing 19 also has a downwardly-depending portion including tubular portion 50 into or onto which will be assembled dip tube 20.

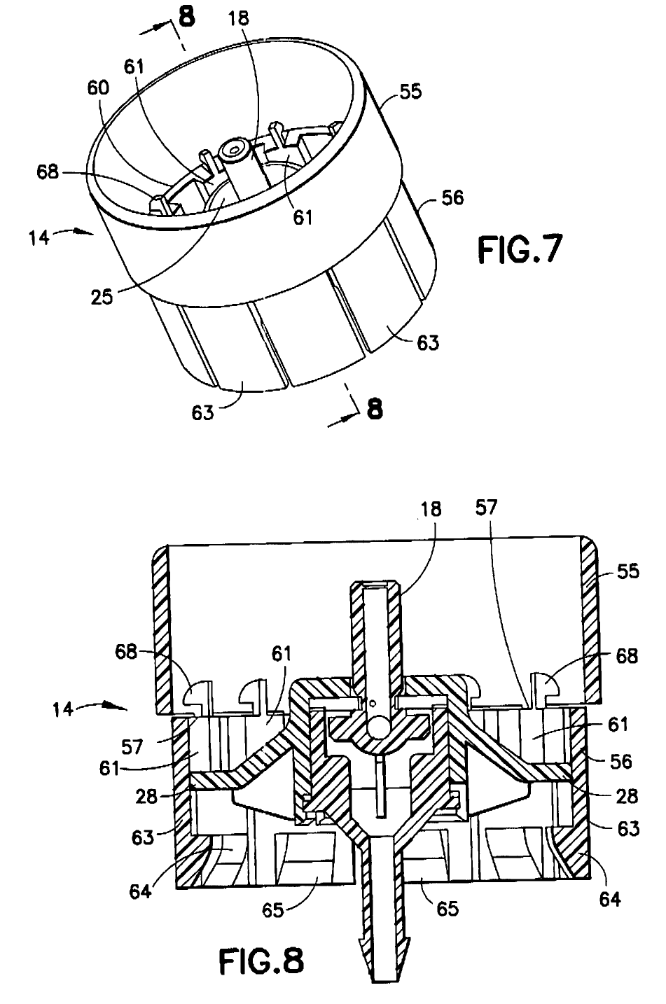

FIGS. 7 and 8 illustrate plastic locking ring 14 having an upper portion 55 and a lower portion 56. Portions 55 and 56 are integrally molded but only connected to each other by spaced thin frangible connections 57 about the locking ring periphery. Alternatively, portion 55 could be metal as previously discussed. Locking ring upper portion 55 has an inner circumference that is only slightly larger than the outer circumference of locking ring lower portion 56, to ultimately allow, as further discussed below, the telescoping of upper portion 55 over lower portion 56 when the frangible connections 57 are broken.

FIGS. 7 and 8 also illustrate the assembly of FIGS. 5 and 6 mounted into locking ring 14. Lower portion 56 of the locking ring has a circumferential top 60 around and from which inwardly extend a plurality of spaced ribs 61. Circumferential horizontal portion 28 of mounting cup 15 abuts against the lower ends of the spaced ribs 61 when the mounting cup is inserted into the bottom of lower portion 56 of locking ring 14. Extending downwardly to form the side of lower portion 56 are a plurality of spaced legs 63 which terminate in inwardly directed flanges 64 with lead-in ramps 65. Horizontal peripheral portion 28 of the mounting cup cams up and snaps past the ramps 65 and flanges 64 upon insertion of the mounting cup 15 into the lower portion 56 of the locking ring 14. The FIG. 8 position of the mounting cup 15 in the locking ring 14 is thereby attained.

Accessory fittings 68 may also be molded onto the tops of ribs 61 of the lower portion 56 of the locking ring, for the placement of domed actuators, etc. if desired.

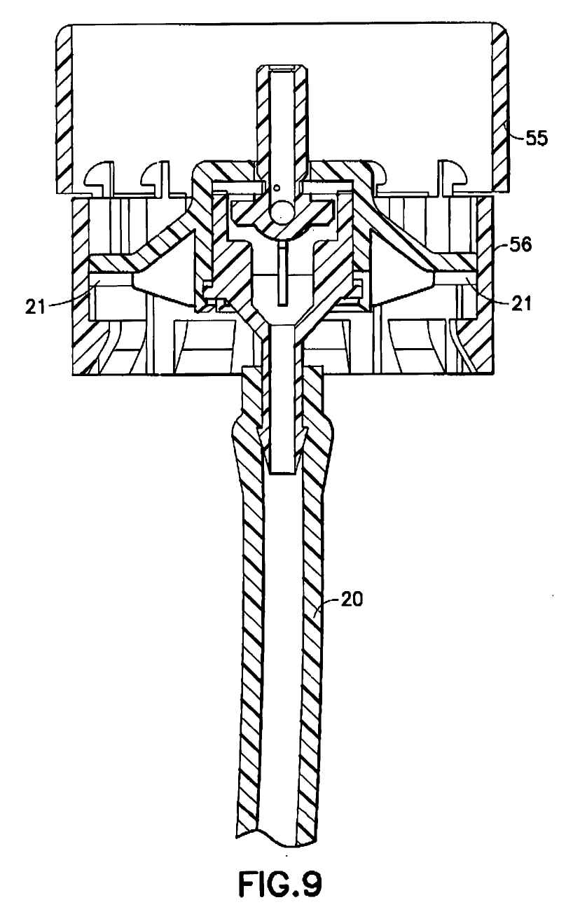

FIG. 9 differs from FIGS. 7 and 8 only in that mounting cup sealing gasket 21 and dip tube 20 have been added. The function of sealing gasket 21 is discussed hereafter. FIG. 9 represents the assembled aerosol valve of the present invention prior to being provided to product fillers for mounting on the plastic product bottle 11.

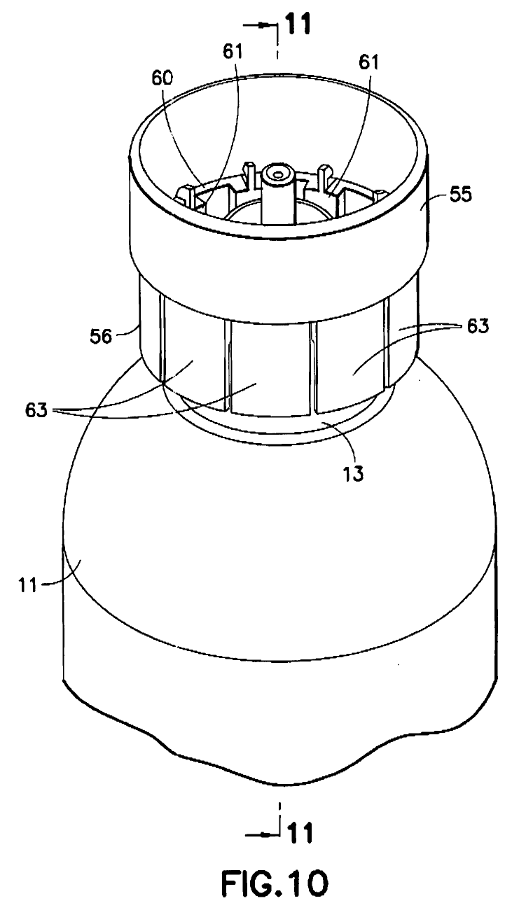

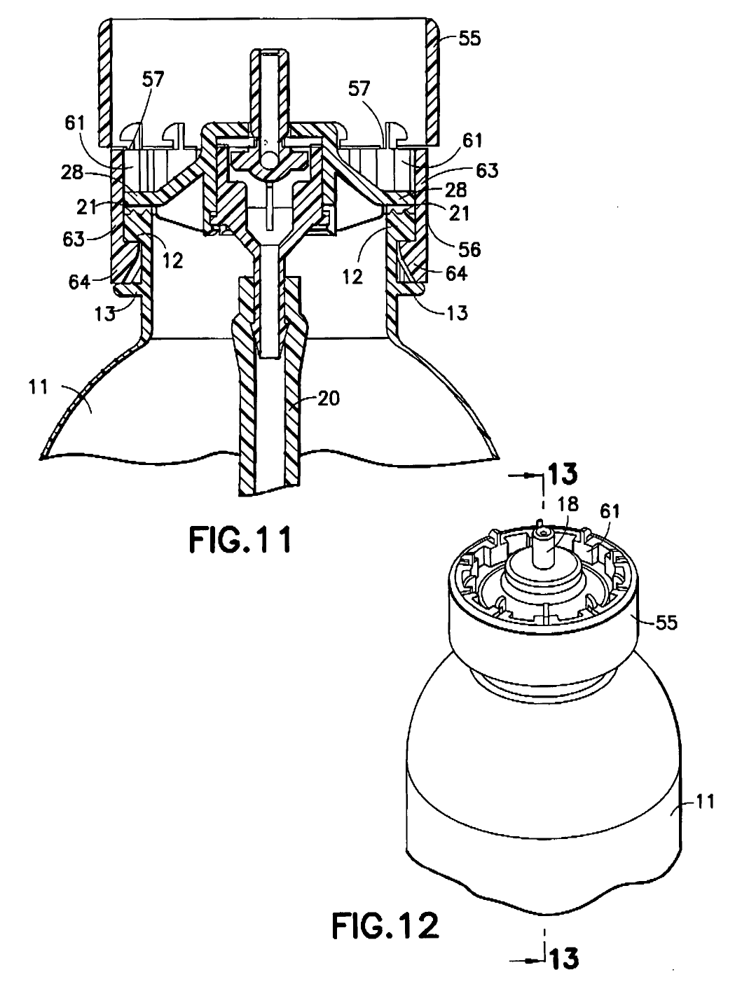

Referring now to FIGS. 10 and 11, it will be seen that the FIG. 9 aerosol valve assembly of the present invention has been mounted and installed onto plastic bottle 11. This is accomplished by snap fitting inwardly directed flanges 64 of locking ring 14 over outwardly directed upper flange 12 on the neck of bottle 11 to fit between flanges 12 and 13 of the bottle neck. Flanges 64 are robust and will extend inwardly a sufficient distance to retain the valve assembly on the bottle 11 when pressurized. When the locking ring flanges are of PET, by-pass shut-offs may be used in the molding thereof to assure jumping the flanges during molding. The flex of legs 63 outwardly assists in this mounting operation. The inner diameter of lower portion 56 also may be slightly less than the outer diameter of the bottle neck and flange 12, so that legs 63 will deflect slightly outward. Such an orientation will assist a tight lock-up when upper portion 55 is telescoped downwardly. The overall dimensioning of parts is such that mounting cup sealing gasket 21 is compressed between the top of the neck of bottle 11 and the circumferential horizontal portion 28 of the periphery of mounting cup 15 which in turn is pressed up against previously described ribs 61. The mounting cup 15, and bottle 11 and its contents, are thereby sealed with respect to one another.

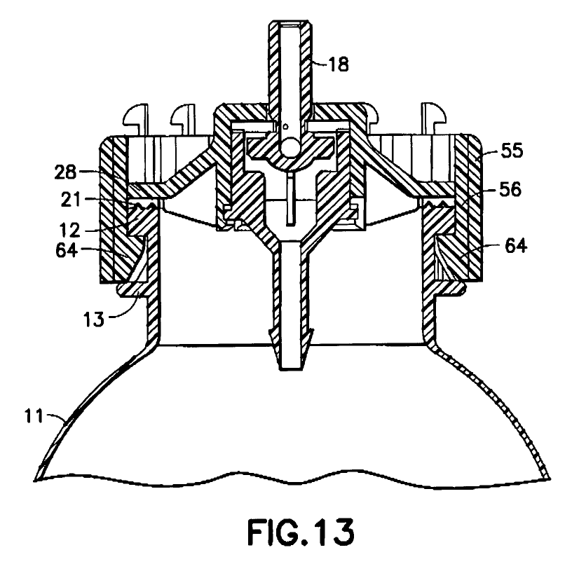

FIGS. 12 and 13 represent the final stage of mounting and locking the aerosol valve to bottle 11. Upper portion 55 of locking ring 14 has been pushed downwardly to telescope over lower portion 56, in the process breaking the spaced thin frangible connections 57 between upper and lower portions 55 and 56 as they are integrally molded. Upper ring portion 55 thus acts as a retainer over lower ring portion 56 to provide hoop strength so that the locking ring 14 and the aerosol valve cannot be dislodged from the neck of the bottle.

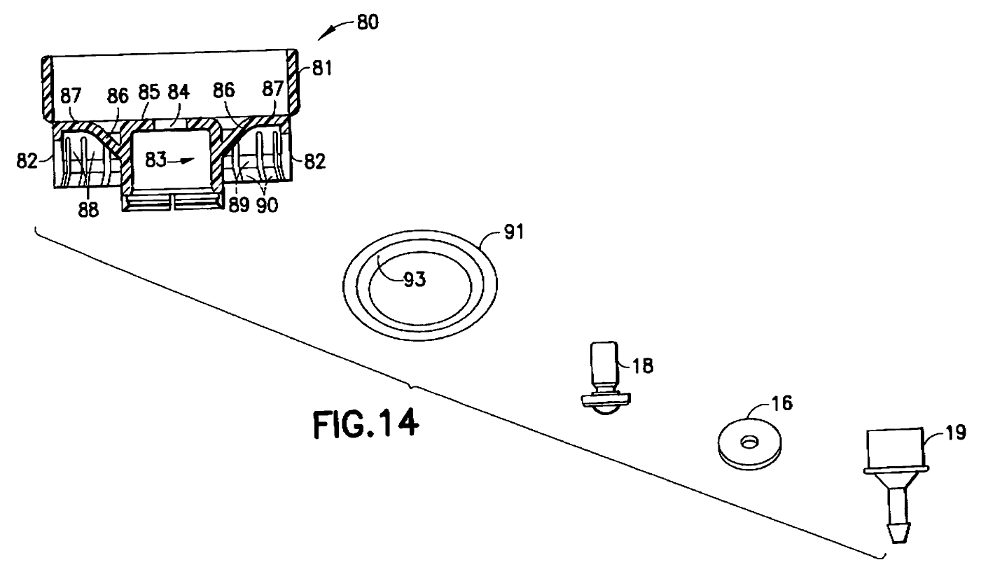

An alternative second embodiment of the present invention is disclosed in FIGS. 14, 15, 16 and 17. An essential difference in this embodiment from the embodiment of FIGS. 1-13, is that the plastic mounting cup is molded integrally with the plastic locking ring. Referring to FIG. 14, locking ring 80 is shown having upper ring portion 81 and lower ring portion 82. Mounting cup 83 is integrally molded to the top of lower portion 82 of the locking ring 80. Hole 84 in the pedestal 85 top of the mounting cup 83 is for valve stem 18. Valve stem 18, stem gasket 16, plastic valve housing 19, dip tube 20, and plastic bottle 11 with neck flanges 12 and 13 are the same parts as shown in FIG. 2 and function in the same manner. Rubber (or TPE) mounting cup sealing gasket 91 is somewhat similar to gasket 21 of FIGS. 2 and 11 and is further described hereafter.

Mounting cup 83 has upwardly and outwardly angled circumferential portion 86, and horizontal circumferential peripheral surface 87 integrally molded with the top of lower portion 82 of locking ring 80. Lower portion 82 has downwardly depending spaced legs 88 with inwardly extending flanges 89 with camming surfaces 90. The structure and functioning of locking ring 80 is the same as that of locking ring 14 in the first embodiment of the present invention with the exception of the integrally joined mounting cup of the alternative second embodiment.

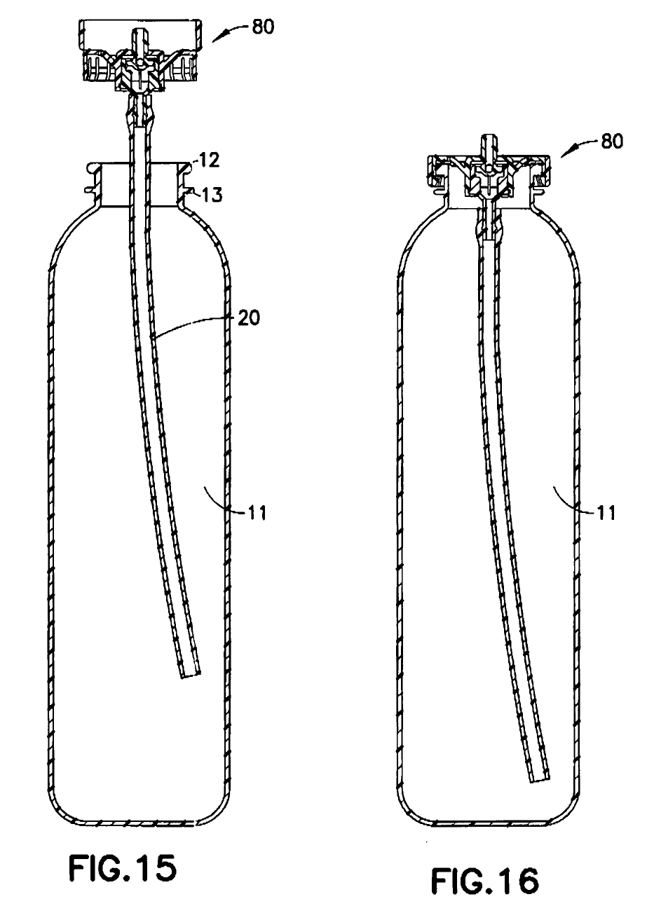

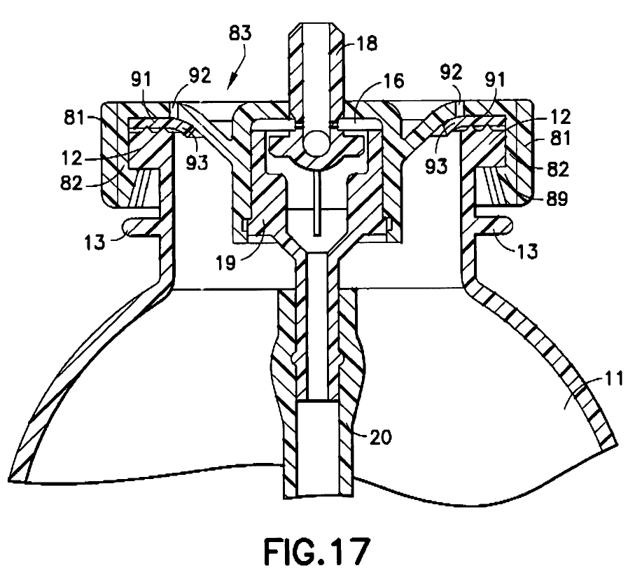

Turning to FIGS. 15, 16 and 17, plastic mounting cup 83 has valve stem 18 and stem gasket 16, valve housing 19, and mounting cup sealing gasket 91, installed therein in the manner previously described above for the first embodiment. FIG. 15 shows the assembled aerosol valve positioned above bottle 11. FIG. 16 shows the locking ring 80 with the assembled aerosol valve pushed down onto the neck of bottle 11, including lower portion 82 and upper portion 81 of the locking ring, all as described and shown in FIGS. 10-13 of the first embodiment and as shown for the second embodiment in expanded detail in FIG. 17.

Referring further to FIG. 17, openings 92 in the top of mounting cup 83 may be used for gassing into bottle 11. Gasket 91 initially has an inward and downwardly directed portion 93. Gasket 91 closes off openings 92 except during filling when the filling pressure and flow deflect portion 93 of gasket 91 further downward until the filling ceases.

It will be appreciated by persons skilled in the art of aerosol valves that variations and/or modifications may be made to the means and method of the present invention without departing from the spirit and scope of the invention. The above embodiments are, therefore, to be considered as illustrative and not restrictive.

What is claimed is:

1. A plastic aerosol valve assembly, comprising in combination a plastic valve stem, a plastic valve housing, a plastic mounting cup and a plastic locking ring; said plastic housing having a snap fit connection with said plastic mounting cup; said plastic locking ring having flanges for snap fitting onto the neck of a product container and including a retaining ring to maintain said flanges on the neck of the product container.

2. The plastic aerosol valve assembly of claim 1, wherein said plastic mounting cup has a snap connection with said plastic locking ring.

3. The plastic aerosol valve assembly of claim 1, wherein said plastic mounting cup is integrally molded with said plastic locking ring.

4. The aerosol valve assembly of claim 1, wherein said locking ring has an upper retaining ring portion and a frangibly connected lower portion, said flanges extending inwardly of the said lower portion.

5. The aerosol valve assembly of claim 1, wherein said locking ring has an inner portion with said flanges extending inwardly of the inner portion, said locking ring further having an outer portion telescoped over said inner portion.

6. The aerosol valve assembly of claim 1, wherein said plastic valve stem contains a movable check ball.

7. The aerosol valve assembly of claim 1, characterized by the absence of a valve stem return spring and including a valve stem sealing gasket fitting with a groove in the valve stem.

8. The aerosol valve assembly of claim 1, wherein the plastic mounting cup, plastic locking ring, and plastic valve housing are PET.

9. The aerosol valve assembly of claim 1, also including a mounting cup sealing gasket.

10. The aerosol valve assembly of claim 1, wherein the mounting cup includes spaced support ribs positioned radially inward of the mounting cup periphery.

11. A plastic product container and a plastic aerosol valve assembly mounted and retained on the plastic product container, said valve assembly comprising in combination a plastic valve stem, a plastic valve housing, a plastic mounting cup and a plastic locking ring; said plastic housing having a snap fit connection with said plastic mounting cup; said plastic product container having a neck with a top opening and a flange outwardly extending from the neck; said plastic locking ring having an inner portion with flanges extending inwardly and snap fitted over the said neck flange of the plastic product container and including an outer retaining ring portion telescoped over said locking ring inner portion.

12. The plastic product container and plastic aerosol valve assembly of claim 11, wherein said plastic mounting cup has a snap connection with said plastic locking ring.

13. The plastic product container and plastic aerosol valve assembly of claim 11, wherein said plastic mounting cup is integrally molded with said plastic locking ring.

14. The aerosol valve assembly of claim 11, wherein said plastic valve stem contains a movable check ball.

15. The aerosol valve assembly of claim 11, characterized by the absence of a valve stem return spring and including a valve stem sealing gasket fitting with a groove in the valve stem.

16. The aerosol valve assembly of claim 11, wherein the plastic mounting cup, plastic locking ring, and plastic valve housing are PET.

17. The aerosol valve assembly of claim 11, also including a mounting cup sealing gasket.

18. The aerosol valve assembly of claim 11, wherein the mounting cup includes spaced support ribs positioned radially inward of the mounting cup periphery.

19. A method of assembling an aerosol valve assembly having a plastic valve stem and a stem gasket, a plastic valve housing, a plastic mounting cup, and a plastic locking ring having an upper portion frangibly connected to a lower portion, comprising assembling the valve stem and stem gasket into the plastic mounting cup and snap fitting the plastic valve housing into the plastic mounting cup.

20. The method of assembly of claim 19, further including snapping the plastic mounting cup into the plastic locking ring.

21. The method of assembly of claim 19 or claim 20, further including snap fitting the lower portion of the plastic locking ring onto the neck of a plastic product container, and telescoping the upper portion of the plastic locking ring downwardly over the lower portion of the plastic locking ring to retain the assembled aerosol valve assembly on the product container.

22. An aerosol valve assembly, comprising in combination a plastic valve stem, a plastic valve housing, a plastic mounting cup and a plastic locking ring member; said plastic housing having a snap fit connection with said plastic mounting cup; said plastic locking ring member having flanges for snap fitting onto the neck of a product container; and a metal retaining ring telescopable over the plastic locking ring member to maintain said flanges on the neck of the product container.

23. The aerosol valve assembly of claim 22, wherein said plastic mounting cup has a snap connection with said plastic locking ring member.

24. The aerosol valve assembly of claim 22, wherein said plastic mounting cup is integrally molded with said plastic locking ring member.

25. The aerosol valve assembly of claim 22, wherein said metal retaining ring is telescoped over the plastic locking ring member.

26. The plastic aerosol valve assembly of claim 4, wherein said plastic locking ring lower portion has a plurality of downwardly extending spaced legs from which the flanges extend inwardly, said lower portion further having an inside diameter slightly smaller than the outer diameter of the product container neck.

27. The aerosol valve assembly of claim 22, wherein said plastic locking ring member has a plurality of downwardly extending spaced legs from which the flanges extend inwardly, said locking ring member further having an inside diameter slightly smaller than the outer diameter of the product container neck.

28. A plastic product container and an aerosol valve assembly mounted and retained on the plastic product container, said valve assembly comprising in combination a plastic valve stem, a plastic valve housing, a plastic mounting cup and a locking ring; said plastic housing having a snap fit connection with said plastic mounting cup; said plastic product container having a neck with a top opening and a flange outwardly extending from the neck; said locking ring having an inner portion with flanges extending inwardly and snap fitted over the said neck flange of the plastic product container and including an outer retaining ring portion telescoped over said locking ring inner portion.

29. The plastic product container and aerosol valve assembly of claim 28, wherein said inner portion is plastic and said outer portion is metal.

30. The plastic product container and aerosol valve assembly of claim 28, wherein said plastic mounting cup has a snap connection with said inner portion.

31. The plastic product container and aerosol valve assembly of claim 28, wherein said inner portion is plastic and said plastic mounting cup is integrally molded with said inner portion.
